(19) United States
(12) Patent Application Publication
(10) Pub. No.: US 2008/0107553 A1
(43) Pub. Date: May 8, 2008

(54) Method of pumping drill cuttings and pump for moving drill cuttings

(75) Inventor: David Mundell, Ayrshire (GB)

Correspondence Address: THOMPSON HINE L.L.P.;Intellectual Property Group, P.O. BOX 8801, DAYTON, OH, 45401-8801, US

(73) Assignee: Clarke UK, Ltd., Coatbridge (GB)

(21) Appl. No.: 11/977,513

(22) Filed: Oct. 25, 2007

(30) Foreign Application Priority Data
Oct. 27, 2006 (GB) 0621354.0

(51) Int. Cl. F04B 15/02; F04B 7/00; B23P 15/00; F04B 19/22; F04B 19/04

(52) U.S. Cl. 417/517; 29/888.02; 29/428

(57) ABSTRACT

A method of assembling a dual cylinder positive displacement drill cuttings pump is provided. The method includes providing a hopper including a front end, a generally open rear end with a generally barrel-shaped sidewall extending therebetween to provide a generally barrel-shaped hopper volume, and an inlet port extending through the barrel-shaped sidewall for delivering material into the generally barrel-shaped hopper volume. A rear hopper wall is provided that includes first and second pumping cylinder openings that are spaced apart from each other and at a common elevation from a bottom of the rear hopper wall. An installation configuration for the drill cuttings pump is identified, including a hopper infeed angle. Based upon the identified hopper infeed angle, the hopper is located relative to the rear hopper wall such that an axis of the inlet port of the hopper is positioned substantially at the hopper infeed angle. Then, the hopper is connected to the rear hopper wall.

### TECHNICAL FIELD

This application relates to a method for moving drill cuttings and a dual cylinder positive displacement pump configured to move drill cuttings or other material.

### BACKGROUND

Drill cuttings are the by-product of drilling operations, in particular drilling operations for gas and oil wells. The cuttings include mud, sediment, rock and water as well as various oils, drilling fluids and the like. Because of the hydrocarbon content of drill cuttings, as well as other pollutants, it is desirable to treat the drill cuttings before disposal. Regardless of the mode of treatment and disposal, transport of drill cuttings has presented significant logistical problems, particularly when dealing with drill cuttings produced by offshore oil & gas drilling platforms. Due to the nature of the drill cuttings many types of pumps break down quickly and therefore cannot be used on a commercially viable basis for transporting drill cuttings.

### SUMMARY

In an aspect, a method of assembling a dual cylinder positive displacement pump is provided. The method includes providing a hopper including a front end, a generally open rear end with a generally barrel-shaped sidewall extending therebetween to provide a generally barrel-shaped hopper volume, and an inlet port extending through the generally barrel-shaped sidewall for delivering material into the generally barrel-shaped hopper volume. A rear hopper wall is provided that includes first and second pumping cylinder openings that are spaced apart from each other and at a common elevation from a bottom of the rear hopper wall. An installation configuration for the drill cuttings pump is identified, including a hopper infeed angle. Based upon the identified hopper infeed angle, the hopper is located relative to the rear hopper wall such that an axis of the inlet port of the hopper is positioned substantially at the hopper infeed angle. Then, the hopper is connected to the rear hopper wall.

In another aspect, a dual cylinder positive displacement pump includes a hopper including a front end, a rear end, a generally barrel-shaped sidewall extending therebetween to provide a generally barrel-shaped hopper volume and an inlet port extending through the barrel-shaped sidewall for delivering material into the generally barrel-shaped hopper volume. A rear hopper wall includes first and second pumping cylinder openings that are spaced apart from each other, a front hopper wall with a discharge port that is angularly offset from the inlet port and a swing tube assembly within the hopper. A first pumping cylinder is in communication with the first pumping cylinder opening and a second pumping cylinder is in communication with the second cylinder opening.

In another aspect, a method of installing a dual cylinder positive displacement drill cuttings pump for moving drill cuttings includes rotating a hopper including a body having a generally barrel-shaped opening extending therethrough and an inlet port in communication with the barrel-shaped opening. The barrel-shaped opening has an elongated, longitudinal axis with the inlet port rotating about the elongated, longitudinal axis to align the inlet port with a drill cuttings infeed conduit. Then, the hopper is connected to a rear hopper wall including first and second pumping cylinder openings that are spaced apart from each other and at a common elevation from a bottom of the rear hopper wall.

Other advantages and features of the invention will be apparent from the following description of particular embodiments and from the claims.

### BRIEF DESCRIPTION OF DRAWINGS

FIG. 1 is a side section view of an embodiment of a pump for pumping drill cuttings;

FIG. 2 is a top section view of the pump of FIG. 1;

FIGS. 3-5 are side and end views of an embodiment of a hopper for use with the pump of FIG. 1;

FIG. 6 is a top, partial section view of the hopper along line 6-6 of FIG. 4;

FIG. 7A is a section view of the hopper along line 7-7 of FIG. 6;

FIG. 7B is a section view of another embodiment of a hopper along line 7-7 of FIG. 6;

FIG. 8 is an end view of the hopper of FIGS. 3-5 in a top dead center orientation;

FIG. 9 is an end, section view of the hopper of FIGS. 3-5 in a side orientation;

FIG. 10 is an end, section view of the hopper of FIGS. 3-5 in a bottom dead center orientation; and

FIG. 11 illustrates an embodiment of a method of installing the pump of FIG. 1.

### DETAILED DESCRIPTION

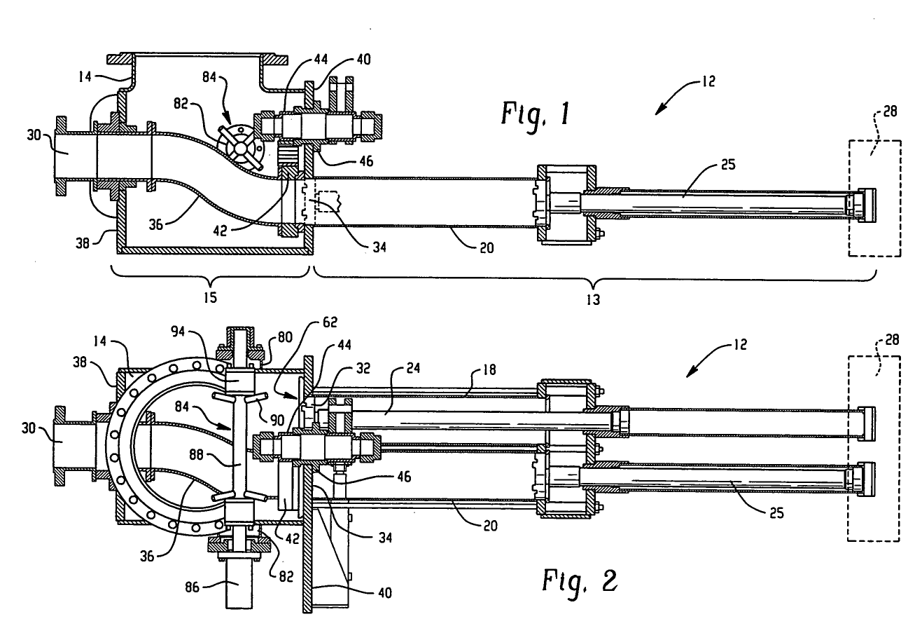

Referring to FIGS. 1 and 2, a dual cylinder positive displacement pump 12 is hydraulically activated and includes a pumping portion 13 and a hopper portion 15. The pumping portion 13 includes first and second hydraulic pumping cylinders 18 and 20 each having an associated piston 24, 25 positioned for reciprocating movement therein. The pistons 24 and 25 in cylinders 18 and 20 are reciprocated back and forth via a hydraulic control unit 28, sometimes also referred to as a power pack, (shown diagrammatically). Two cylinder ports 32 and 34 in a rear plate 40 are in communication with cylinders 18 and 20 and are located at a common elevation above a bottom of the rear plate.

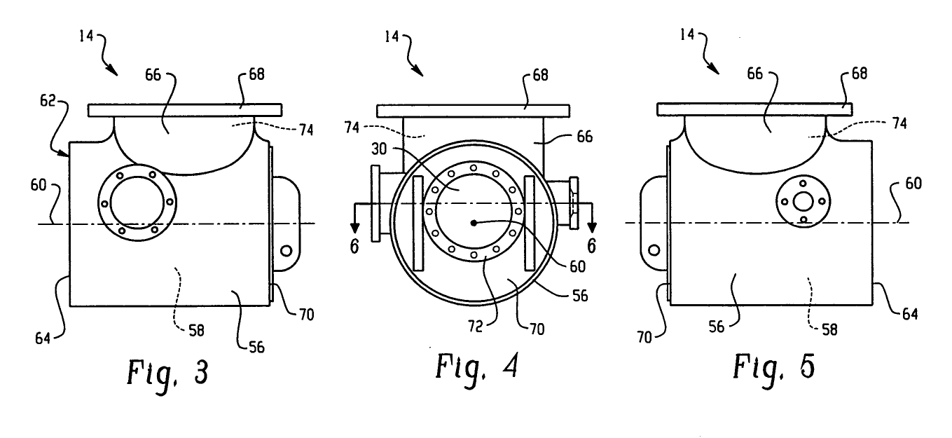

The hopper portion 15 includes a hopper 14 having an outlet or discharge port 30 in a front wall 38 and an opening 62 (FIG. 3) in communication with the cylinder ports 32 and 34. An S-shaped swing tube 36 is used to communicate between the cylinder ports 32 and 34 and the discharge port 30. The swing tube 36 has an outlet end pivotally connected in communication with the outlet port 30 and an inlet end movable between the cylinder ports 32 and 34 in rear plate 40. The swing tube 36 may be supported by a swing tube bracket 42 inside the hopper 14, where movement of the bracket 42 effects movement of the inlet end of the swing tube.

The bracket 42, in turn, is pivotally connected to the rear plate 40 on a shaft 44. The bracket 42 is fixed to the shaft 44 allowing it to swing back and forth and at the same time direct the swing tube 36 back and forth to align with the ports 32 and 34. On the rearward side of rear plate 40 a collar 46 is keyed to shaft 44. The collar 46 is rotated back and forth mechanically (for example, by hydraulic pistons attached to the collar 46 by chevises). A single hydraulic piston, or some other mechanism, could also be used to effect movement of the swing tube 36.

The outlet port 30 may communicate with a discharge conduit that includes a diversion valve which can be triggered to redirect drill cuttings from the discharge conduit back along a feedback path, as may be defined by one or more conduits leading to a holding bin that communicates with hopper 14. Selective use of the feedback path can maintain the consistency of the drill cuttings when the flow of the drill cuttings through the discharge conduit is terminated for one reason or another.

Hopper 14 includes respective mount openings 80 and 82 for receiving an agitator assembly 84. Agitator assembly 84 includes a driving motor 86 mounted exteriorly of the hopper 14 and associated with a primary agitator shaft 88 on which spaced apart agitator extensions 90 are provided. The opposite end of shaft 88 is associated with a bearing assembly 94 of the opening 80. Thus, the agitator assembly extends between opposite sides of the hopper 14 to be supported above the swing tube 36 within the hopper. As reflected by the position of opening 82, the agitator assembly 84 is positioned off-center of the front to rear length of the hopper 14, and particularly toward the rear. Rotation of the shaft 88 of agitator assembly 84 causes the agitator extensions 90 to work drill cuttings within the hopper 14.

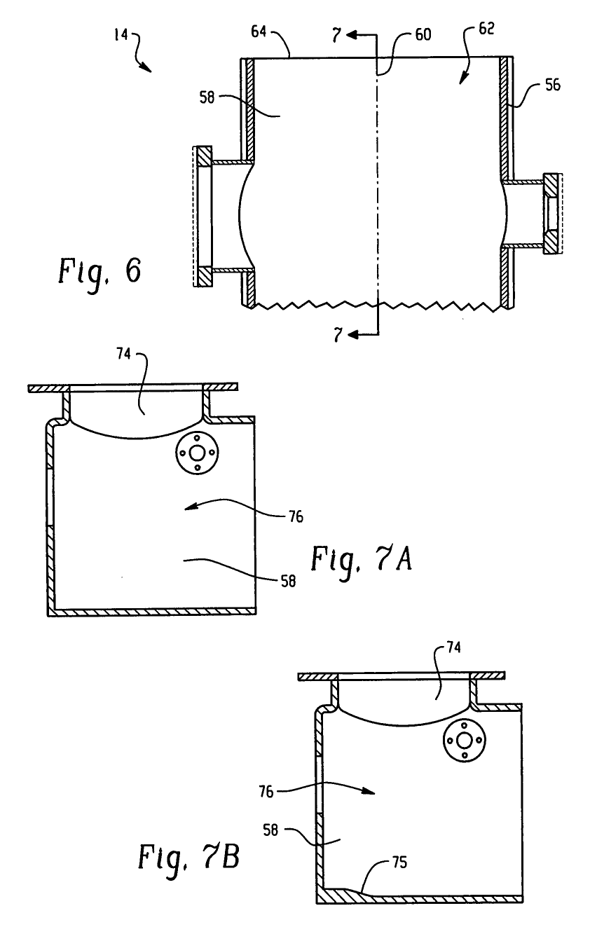

Referring now to FIGS. 3-6, hopper 14 is shown in isolation and unconnected to the pumping portion 13 (e.g., prior to installation). Hopper 14 includes a body 56 having a round bore 58 therein (FIG. 6), which, in the illustrated embodiment, forms a generally barrel-shaped volume. In some embodiments, round bore 58 is cylindrical having an elongated, longitudinal axis 60 extending therethrough. Opening 62 is in communication with the round bore 58 and is disposed at a rear end 64 of the hopper 14. Extending outwardly (e.g., at about 90 degrees from the elongated, longitudinal axis) from the body 56 is an inlet port 66 that is in communication with the round bore 58. Inlet port 66 has a bore 74 that intersects the round bore 58. Inlet port 66 includes a flange 68 that can be used to connect the hopper 14 to a drill cuttings infeed conduit.

Outlet port 30 (FIG. 4) is located at the front end 70 of the body 56 opposite the rear end 64. Outlet port 30 includes a flange 72 that can be used to connect the hopper 14 to the discharge conduit.

Referring now to FIG. 7A, in one embodiment, the intersecting bores 58 and 74 form a somewhat T-shaped chamber 76 within the hopper 14 (e.g., having a capacity of about 50 gal. or more such as about 66 gal.). In one embodiment, both bores 58 and 74 are cylindrical, for example, having intersecting axes. Referring to FIG. 7B, in another embodiment, hopper 14 includes a slanted surface 75 that can urge drill cuttings toward the opening 62 at rear end 64.

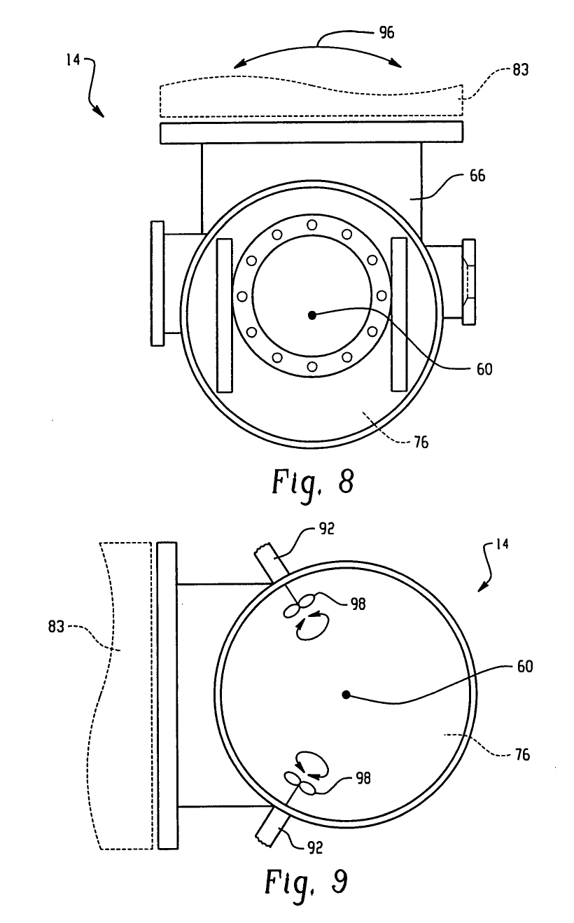

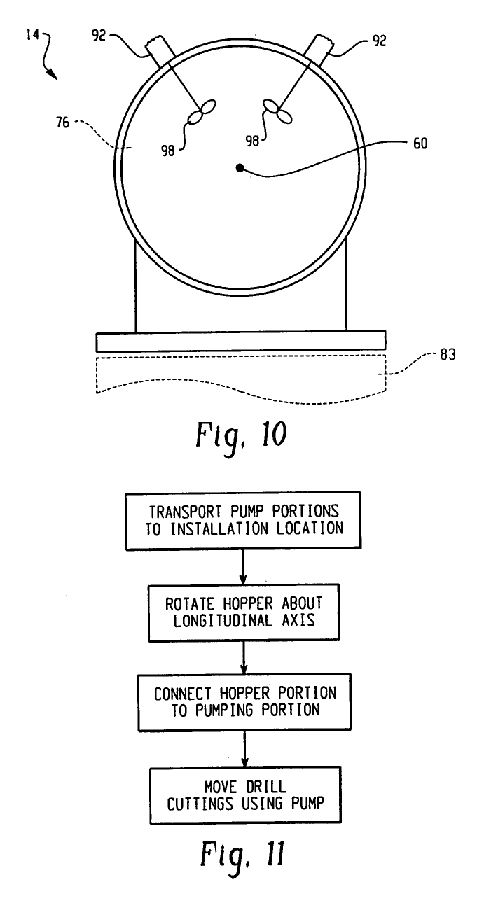

Referring now to FIGS. 8-10, hopper 14 and its chamber 76 are shaped so that the hopper can be positioned at various angular arrangements about axis 60 (e.g., through 360 degrees; see arrow 96) to accommodate, for example, various rig or ship installation restrictions. For example, FIG. 8 shows the hopper 14 in a top dead center (TDC) orientation with the inlet port 66 facing vertically upward for connecting to a drill cuttings infeed conduit 83 (illustrated by dotted lines) disposed thereabove, FIG. 9 shows the hopper in a side configuration with the inlet port located about 90 degrees from the TDC orientation for connecting to a drill cuttings infeed conduit 83 (illustrated by dotted lines) disposed therebeside and FIG. 10 shows the hopper in a bottom dead center (BDC) orientation with the inlet port facing vertically downward for connecting to a drill cuttings infeed conduit 83 (illustrated by dotted lines) disposed therebelow. Once the hopper 14 is positioned at the desired angular orientation, for example, in the TDC orientation of FIG. 8, the hopper can be connected (e.g., welded) to the plate 40 of the pumping portion 13 as shown in FIGS. 1 and 2.

In some orientations such as those shown by FIGS. 9 and 10, the agitator assembly 84 may be replaced by a different agitator configuration, such as two separate hydraulic motors 92 driving a remixer propeller 98 mounted through the hopper 14 wall. The hydraulic motors 92 may be capable of driving the propellers 98 in both clockwise and counterclockwise directions. The agitator along with the round-shaped volumes forming chamber 76 will facilitate flow of the drill cuttings during operation. A suitable hydraulic motor for driving the remixer propeller is commercially available from Eaton Corp.

FIG. 11 shows an exemplary method 100 for installing the pump 12. The pumping portion 13 and hopper portion 15 are transported to, for example, an oil drilling rig, ship or barge at step 102. At step 104, the hopper 14 is rotated about its longitudinal axis 60 to align the inlet port 66 and flange 68 with an infeed conduit for attachment thereto (e.g., by welding and/or fastening). It should be noted that only the body 56 of the hopper 14 is rotated, in some embodiments, with the remaining components of the pump 12 remaining stationary or not rotating with the body of the hopper. The pumping portion 13 may already installed prior to step 104, or the pumping portion may be installed thereafter. Once the hopper 14 is oriented, the hopper and plate 40 of the pumping portion 13 are connected (e.g., welded) together at step 106 and the outlet port 30 is connected (e.g., welded and/or fastened) to the discharge conduit.

Once the pump 12 is installed, referring back to FIGS. 1 and 2, drill cuttings and muds are placed in hopper 14. The pistons 24 and 25 in cylinders 18 and 20 will reciprocate back and forth. When the piston 24 is moving rearwardly, the swing tube is in alignment with the cylinder 20 leaving the opening 32 in communication with the interior of the hopper 14. Thus, the drill cuttings are drawn into the cylinder 18 as the piston 24 is pulled backwards. At the same time the piston 25 in cylinder 20 is moving forward. The swing tube 36 is aligned with the port 34 and the drill cuttings are pushed by the piston 25 through the swing tube 36. Once the right piston 25 has completed its stroke, the hydraulic cylinders 48 and 50 attached to the collar 46 cause the swing tube 36 to swing in the opposite direction as indicated by arrow 68 aligning the swing tube 36 with the cylinder 18. During movement of the inlet end of the swing tube 36 movement of the pistons 24 and 25 is temporarily paused. Once the movement of the swing tube 36 is completed, the piston 24 in cylinder 18 then moves forward forcing the drill cuttings in the cylinder 18 through the swing tube 36. At the same time the piston 25 in the right cylinder 20 moves backwards drawing in drill cuttings. This action continues repeatedly so that drill cuttings continue to be drawn from the hopper into the pumping cylinders and then moved from the pumping cylinders along the swing tube to the discharge port 30 and into a discharge tube.

Various features useful for incorporation into pump 12 are described in U.S. patent application Ser. No. 11/191,246, entitled Method of Pumping Drill Cuttings and Dual Cylinder Positive Displacement Pump for Moving Drill Cuttings, filed Jul. 27, 2005, the content of which is hereby incorporated by reference as if fully set forth herein.

The pumping capacity of a dual cylinder positive displacement pump for pumping drill cuttings will tend to vary with the size of the pump and the application to which the pump is applied (e.g., whether the pump is simply transferring drill cuttings from one storage location to another or whether the pump is being used to feed drill cuttings to a processing system having a limited capacity).

In one application a dual cylinder positive displacement pump 12 is used on an offshore drilling platform to move drill cuttings into a unit for processing of the drill cuttings. In another application the pump is used to pump the drill cuttings off of an offshore platform onto a seagoing vessel such as a barge so that the drill cuttings can be transported to a land-based processing facility. In the latter case, the pump may be associated with a movable discharge tube, such as a high pressure hose or conduit, that can be aligned with a hatch or other opening on the vessel. The hopper 14 may be formed of any suitable material such as heavy duty steel.

The above-described hopper 14 can allow for installation at a location where available space is limited, for example, on board oil drilling rigs or below the decks of ships or barges.

Depending on the orientation of the hopper 14 and infeed conduit, pump 12 can be fed from the top, bottom, either side or from any angle through 360 degrees about the longitudinal axis 60. The shape of the chamber 76 can allow for self-cleaning during a pumping cycle.

It is to be clearly understood that the above description is intended by way of illustration and example only and is not intended to be taken by way of limitation, and that changes and modifications are possible. Accordingly, other embodiments are contemplated and modifications and changes could be made without departing from the scope of this application as expressed by any claims now included or hereafter added.

What is claimed is:

1. A method of assembling a dual cylinder positive displacement pump, the method comprising:
(a) providing a hopper including a front end and a generally open rear end with a generally barrel-shaped sidewall extending therebetween to provide a generally barrel-shaped hopper volume, an inlet port extending through the generally barrel-shaped sidewall for delivering material into the generally barrel-shaped hopper volume;
(b) providing a rear hopper wall including first and second pumping cylinder openings that are spaced apart from each other and at a common elevation from a bottom of the rear hopper wall;
(c) identifying an installation configuration for the drill cuttings pump, including a hopper infeed angle;
(d) based upon the identified hopper infeed angle of step (c), locating the hopper relative to the rear hopper wall such that an axis of the inlet port of the hopper is positioned substantially at the hopper infeed angle; and
(e) subsequent to step (d), connecting the hopper to the rear hopper wall.

2. The method of claim 1 wherein step (e) includes welding the rear hopper wall to the hopper.

3. The method of claim 1, comprising the further steps of:
providing a generally circular front hopper wall with a discharge port offset from a center axis of the front hopper wall; and
connecting the front hopper wall to the front end of the hopper with an angular position of the discharge port offset from the inlet port of the hopper.

4. The method of claim 1, wherein step (d) includes rotating the hopper such that the inlet port is at an angular position offset from vertical and step (e) includes connecting the hopper to the rear hopper wall with the inlet port in the angular position offset from vertical.

5. The method of claim 1 further comprising subsequent to step (d), connecting the inlet port of the hopper to a drill cuttings infeed conduit that defines the hopper infeed angle.

6. The method of claim 1, wherein the inlet port has a cylindrical bore extending therethrough that intersects the generally barrel-shaped hopper volume.

7. The method of claim 1 further comprising positioning an agitator within the barrel-shaped hopper volume for agitating drill cuttings.

8. The method of claim 1 further comprising providing a first pumping cylinder in communication with the first pumping cylinder opening and providing a second pumping cylinder in communication with the second pumping cylinder opening.

9. The method of claim 8 further comprising locating a swing tube adjacent one of the first and second pumping cylinder openings, the swing tube extending through the hopper to a hopper discharge port and being moveable between the first and second pumping cylinder openings for directing drill cuttings from the first and second pumping cylinders to the hopper discharge port.

10. A dual cylinder positive displacement pump, comprising:
a hopper including a front end, a rear end and a generally barrel-shaped sidewall extending therebetween to provide a generally barrel-shaped hopper volume, and an inlet port extending through the barrel-shaped sidewall for delivering material into the generally barrel-shaped hopper volume, a rear hopper wall including first and second pumping cylinder openings that are spaced apart from each other, a front hopper wall with a discharge port that is angularly offset from the inlet port, and a swing tube assembly within the hopper;
a first pumping cylinder in communication with the first pumping cylinder opening; and
a second pumping cylinder in communication with the second cylinder opening.

11. The pump of claim 10, wherein an center axis of the discharge port is positioned vertically above a center axis of the barrel shaped volume, and the inlet port is located at a position offset from vertical.

12. The pump of claim 10, wherein the inlet port has a cylindrical extension from the generally barrel-shaped sidewall with a bore that intersects the generally barrel-shaped hopper volume.

13. The pump of claim 12, wherein the cylindrical extension includes a mounting flange.

14. The pump of claim 10, further comprising a swing tube assembly within the hopper, with one end pivotally connected to the discharge port to permit an opposite end to move between the first and second pumping cylinder openings.

15. The pump of claim 10 further comprising an agitator located in the generally barrel-shaped hopper volume.

16. The pump of claim 15, wherein the agitator includes a propeller and a motor operatively connected to the propeller.

17. A method of installing a dual cylinder positive displacement drill cuttings pump for moving drill cuttings, the method comprising:
rotating a hopper including a body having a generally barrel-shaped opening extending therethrough and an inlet port in communication with the barrel-shaped opening, the barrel-shaped opening having an elongated, longitudinal axis, the inlet port rotating about the elongated, longitudinal axis to align the inlet port with a drill cuttings infeed conduit; then
connecting the hopper to a rear hopper wall including first and second pumping cylinder openings that are spaced apart from each other and at a common elevation from a bottom of the rear hopper wall.

18. The method of claim 17, wherein the step of connecting the hopper to a rear hopper wall comprises welding.

19. The method of claim 17, wherein the step of rotating the hopper includes rotating the hopper such that the inlet port is at an angular position offset from vertical.

20. The method of claim 19, wherein the step of connecting the hopper to the rear hopper wall includes connecting the hopper to the rear hopper wall with the inlet port in the angular position offset from vertical.
